(19) United States
(12) Patent Application Publication
(10) Pub. No.: US 2004/0160873 A1
(43) Pub. Date: Aug. 19, 2004

(54) Method and system for creating an optical drive write strategy for an unknown optical media

(76) Inventor: David M. Pereira, Austin, TX (US)

Correspondence Address: HAMILTON & TERRILE, LLP, P.O. BOX 203518, AUSTIN, TX, 78720, US

(21) Appl. No.: 10/368,792

(22) Filed: Feb. 19, 2003

(51) Int. Cl. G11B 7/0045

(52) U.S. Cl. 369/47.53

(57) ABSTRACT

An optical drive writes information to an optical medium by generating a write strategy for the optical medium from test writes to and test reads from the optical medium. A write module in the optical drive reads an optical medium identification code from the optical medium and determines that the write strategy for the optical medium is unavailable from an optical drive write strategy table. A write strategy development module generates one or more test patterns and plural write strategies to test write to the optical medium and compares the error rates of the test writes to select a test write strategy for the write module to use in writing information to the optical medium. The write strategy development module stores the selected write strategy in the write strategy table indexed by the optical medium identification code for use in writing information to subsequently inserted optical medium having the optical medium identification code associated with the selected test write strategy.

### BACKGROUND OF THE INVENTION

1. Field of the Invention

The present invention relates in general to the field of writing information to optical media, and more particularly to a method and system for creating an optical drive write strategy for writing information to optical media unknown to the optical drive.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

An increasingly popular media for storing information is writable and rewritable optical media, such as CD and DVD disks. Greater consumer demand for writable optical media has led to a greater number of manufacturers of writable optical media and an effort by these manufacturers to improve optical media write speeds by developing new variations in dye formulation and manufacturing parameters. Optical drives store information on these optical media by illuminating an optical medium disk with a focused laser beam that alters the reflective properties of the medium. The information is read from the optical medium by illumination of the medium with a lower powered laser and by measuring the reflectivity of the optical medium. Optical drive manufacturers attempt to store information on optical media to meet standards that require write attempts to be reasonably free from errors. In order to have reasonable writing accuracy, optical drive manufacturers often develop separate write strategies for each type of optical medium by testing disk samples. A write strategy is a combination of write parameters, such as write laser power, pulse shape, pulse width, etc . . . , that permit the optical drive to write to a disk with an acceptable number of errors. Typically, optical drives identify an inserted disk by type and manufacturer from an identification code embedded on the disk by the manufacturer. The optical drive then selects a write strategy for the disk from a stored list of write strategies and applies the selected write strategy to write the information onto the disk.

One difficulty faced by optical drive manufacturers is maintaining the list of write strategies on an optical drive so that optical media developed after the optical drive is in use can have a write strategy added to the list. One solution is for information handling system manufacturers to update optical drive firmware with a current write strategy list immediately before shipping the information handling system to a customer. However, updating a write strategy list generally involves a costly and time consuming re-flash of firmware and does not address write strategies developed after shipment of the information handling system. Although firmware updates sometimes add popular media types to a write strategy list, the update still must be installed and include the media type in use. For situations in which no write strategy is available, optical drive manufacturers typically have a non-optimized generic write strategy available for use. Default generic write strategies typically include a set of write parameters chosen to cover a wide range of optical media characteristics with satisfactory but less than optimal results, such as reduced write quality and slower write speeds.

### SUMMARY OF THE INVENTION

Therefore a need has arisen for a method and system which automatically creates an optical drive write strategy for writing information to an optical medium absent from the write strategy list of an optical drive.

In accordance with the present invention, a method and system are provided which substantially reduce the disadvantages and problems associated with previous methods and systems for writing information to optical media. An optical drive writes information to an optical medium for which the optical drive lacks a write strategy by performing test writes and reads on the optical medium to create a write strategy and then using the created write strategy to write the information to the optical write drive.

More specifically, a write module in the optical drive reads an optical medium identification code from an inserted optical medium and uses a write strategy associated with the optical medium identification code to write information to the optical medium. The write module searches an internal optical drive write strategy list for the optical medium identification code to locate the optical medium's write strategy. If the optical medium identification code is not listed in the optical drive write table, the write module reverts to a default generic write strategy and communicates the use of the default strategy through a command interface to a host information handling system write application. The write application obtains user consent to generate a write strategy for the optical medium by performing test writes and reads on the optical medium. Consent to create a test write strategy is communicated to a write strategy development module which performs test writes and reads to identify write parameters having improved readability over the default write strategy and saves the write parameters as a write strategy to the optical drive's write strategy table indexed to the optical medium's identification code. The write strategy is provided to the write module for use in writing the information to the optical medium instead of the default generic write strategy.

The present invention provides a number of important technical advantages. One example of an important technical advantage is that an optical drive automatically creates a write strategy and updates its write strategy list for writing information to an optical medium if a write strategy for the optical medium in the optical drive is absent from the optical drive's write strategy list. The created write strategy is stored indexed to the optical medium identification code for use with subsequent writes to optical media having the same identification code. The availability of a write strategy instead of the use of the generic write strategy provides more rapid and accurate information writes with minimal cost or disruption to the information handling system user.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a system for creating an optical drive write strategy for an unknown optical medium; and

FIG. 2 depicts a process for creating an optical drive write strategy for an unknown medium.

### DETAILED DESCRIPTION

An optical drive writes information to an optical medium type, such as type categorized by manufacturer, for which the optical drive lacks a write strategy by developing a write strategy for the optical medium from test writes to and test reads from the optical medium with plural test write strategies. The optical drive writes information provided by an information handling system to the optical medium type with the optical-drive-created write strategy that provides desired readability. For purposes of this application, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

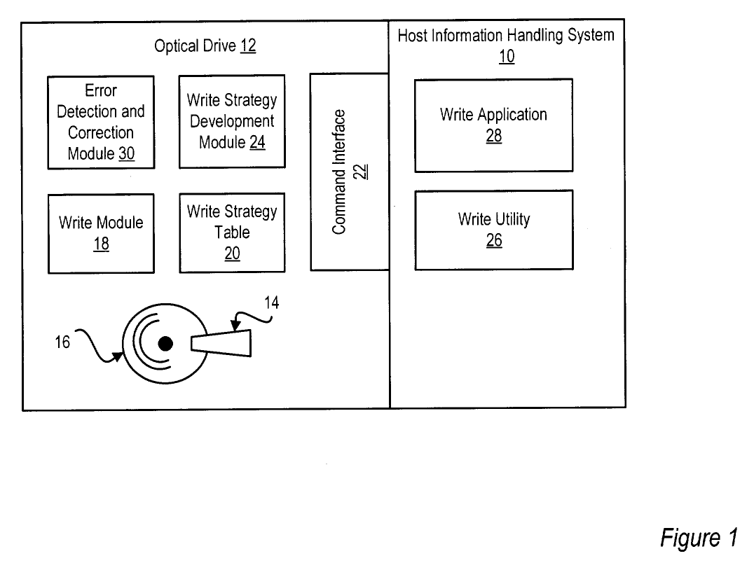

Referring now to FIG. 1, a block diagram depicts a system for creating an optical drive write strategy for writing information to an, optical medium type having an identification code not recognized by the optical drive. A host information handling system 10 interfaces with and supports the operation of an optical drive 12 having a laser 14 operable to read information from and write information to an optical medium disk 16, such as a CD-R, CD-RW, DVD-R, DVD+RW or DVD-RAM disk. Host information handling system 10 generates information to write to optical medium disk 16 by running applications with components such as the CPU. Optical medium disk 16 has an identification code or other identification indicia stored by its manufacturer, typically embedded in a non-user accessible area. The optical medium identification code uniquely identifies the optical medium type by manufacturer and formulation and is associated by drive manufacturers with a write strategy for writing information to disks of the optical medium type. For instance, the write strategy defines the pulse power, shape, width, timing, step characteristics and other parameters used by laser 14 to write information to optical medium disk 16. When an optical medium disk 16 is inserted in optical drive 12, a write module 18 identifies the particular type of disk 16 by reading the embedded identification code or other identification indicia and obtains the write strategy for the optical medium disk by looking up the identification code in an optical drive write strategy table 20. Optical drive write strategy table 20 stores in non-volatile memory of optical drive 12 plural write strategies for different types of optical media cross referenced by the optical medium identification code or other identification indicia.

If write module 18 fails to locate the optical medium identification code of an inserted optical medium disk in optical drive write strategy table 20, then write module 18 instead locates a default generic write strategy associated with unknown optical medium identification codes. Write module 18 communicates through a command interface 22 to host information handling system 10 a request to generate a write strategy for the optical medium identification code read from optical medium disk 16 with a write strategy development module 24. If write strategy development module 24 is granted consent to generate a write strategy in response to the request, then write module 18 applies that generated write strategy to write information to optical medium disk 16 and updates optical drive write strategy table 20 with the generated write strategy referenced by the optical medium identification code so that subsequent writes to optical medium disks having that identification code are handled internally within optical drive 12 by writing the information with the stored write strategy.

In one embodiment, command interface 22 coordinates the request for a write strategy with the write application 28 that coordinates information writes from host information handling system 10 to optical medium disk 16. Alternatively, command interface 22 coordinates the request for a write strategy through a write utility 26, such as a module incorporated in an operating system driver for optical drive 12. Either write application 28 or write utility 26 presents to the user of host information handling system 10 the option to continue with the write using the default generic write strategy or to generate a write strategy for the optical medium. For instance, a graphical user interface provides an explanation that generating a write strategy will cause a delay in the write and use disk space in non-rewritable optical media but that better future writes are available for similar optical medium types without delay once a write strategy is developed for the optical medium. Thus, for instance, a user may elect to develop a write strategy if the user has a substantial number of unused optical medium disks of the same type but may elect to proceed with an undelayed write if the use or optical medium disk type is a one-time or rare occurrence. If the user elects to proceed with the information write without generating a write strategy, write module 18 proceeds with the information write using the default generic write strategy. If the user elects to generate a write strategy, the request is provided to write strategy development module 24. Additionally, the user may specify the extent of the write strategy development by placing time or space constraints. For instance, the user may specify minimal writes or test time to the inserted optical medium or may allow extensive test time with the complete consumption of a non-rewritable optical medium disk to allow a more precise write strategy development.

Write strategy development module 24 generates test pattern information for writing to optical medium disk 16 with a variety of test write strategies so that test reads of the written test patterns allows selection of a test write strategy that provides improved readability of information compared with information written by the default generic write strategy. For instance, an error detection and correction module 30 included in optical drive 12, which normally performs error detection and correction functions for optical drive write process, is used to read the test information and determine the write strategy having the best readability by selecting the test write strategy having the least C1 and C2 error rates, the lowest jitter or other write quality indicator. In one embodiment, write strategy development module 24 generates a single test write using plural write strategies, each of which has an incremental adjustment of one or more write strategy parameters. Upon completion of the single test write, error detection and correction module 30 reads the test information for comparison with the test pattern to determine the write strategy that wrote the test pattern with the lowest error rate. Alternatively, in another embodiment, one or more test information writes are followed by test reads in an iterative optimization method that applies test read results to modify subsequent test write strategies. For instance, if a test write strategy having an iterative increase of a write strategy parameter has a test read indicating improved readability, the subsequent test write increases the write strategy parameter by additional iterations until readability decreases. The test write strategy that provides the best write performance is stored by write strategy development module 24 in write strategy table 20 indexed to the optical medium identification code of the test optical medium for use in subsequent writes to optical mediums having the same identification code.

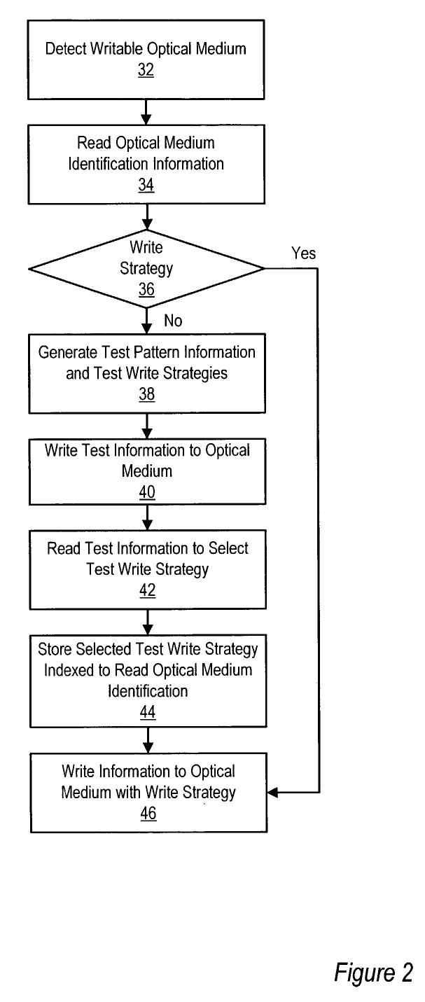

Referring now to FIG. 2, a flow diagram depicts a process for setting optical drive write strategies to write information to an optical medium. The process begins at step 32 with insertion of an optical medium into an optical drive and detection by the optical drive of the optical medium as writable. At step 34, the optical drive reads the optical medium type from the identification information code embedded on the optical medium by the manufacturer. At step 36, the optical drive determines if a write strategy is available for the identified medium type. If a write strategy is available, the process continues to step 46 for a write of the information to the optical medium with the write strategy available for the identified optical medium type.

If the determination at step 36 is no, i.e., that a write strategy is not available for the optical medium type associated with the identification code, then the process continues to step 38 for generation of test pattern information and test write strategies for writing by the optical drive to the optical medium. At step 40, test information for the test pattern and test write strategies is written to the optical medium. For instance, an identical test pattern is repeatedly written in a single step to the optical medium with each write of the test pattern having a different one of plural test write strategies. At step 42, the test information is read by the optical drive from the optical medium to determine the readability of each test pattern write for selecting the write strategy having the best readability results. The test write strategy having the best readability, such as the lowest error rate, is selected as the write strategy for optical media having the identification code of the test optical medium. At step 44, the selected test write strategy is stored in non-volatile memory of the optical drive indexed by the associated optical medium identification code. At step 46, the information is written to the optical medium with the write strategy.

Although the present invention has been described in detail, it should be understood that various changes, substitutions and alterations can be made hereto without departing from the spirit and scope of the invention as defined by the appended claims.

What is claimed is:

1. An information handling system comprising:
a host having plural components operable to run applications;
a write application operable to run on the host to generate information;
an optical drive interfaced with the host and operable to write the information to an optical medium according to a write strategy;
a write strategy table integrated with the optical drive and having plural write strategies, each write strategy associated with an optical medium identification;
a write module interfaced with the write strategy table, the write module operable to read an optical medium identification from the optical medium and to either select a write strategy associated with the optical medium identification from the write strategy table or select a generic write strategy if the optical medium identification is missing from the write strategy table; and
a write strategy development module interfaced with the write module and operable to perform test writes and reads to the optical medium to develop a write strategy having desired write quality measurements for the write module to write the information to the optical medium.

2. The information handling system of claim 1 wherein a write strategy comprises plural parameters, and wherein the write strategy development module test writes are incremental adjustments to one or more generic write strategy parameters.

3. The information handling system of claim 2 wherein the incremental adjustments comprise a test write of all incremental adjustments followed by a test read of the test write to identify the incremental adjustment associated with at least a desired error rate as the write strategy for the optical medium.

4. The information handling system of claim 2 wherein the incremental adjustments comprise plural iterative test writes, each iterative test write adjusting one or more write parameters followed by a test read to determine the error rate of the iterative test write.

5. The information handling system of claim 4 wherein the write strategy development module analyzes the error rate associated with an iterative test write to determine the write parameters for the subsequent test write.

6. The information handling system of claim 2 wherein write strategy parameters comprise one or more of a write laser power setting, a write laser pulse shape or a write laser pulse width.

7. The information handling system of claim 1 wherein the write strategy development module is further operable to load the developed write strategy to the write strategy table indexed by the optical medium identification.

8. The information handling system of claim 1 wherein the write application is further operable to present to the user the option to write the information with the generic write strategy or a write strategy developed by the write strategy development module.

9. A method for setting an optical drive write strategy to write information to an optical medium, the method comprising:
reading an optical medium identification from an optical medium with an optical drive;
determining that the optical drive lacks a write strategy for the optical medium identification;
performing plural writes of test information to the optical medium with plural write strategies;
reading the plural writes to select a write strategy having a desired readability; and
using the selected write strategy to write the information to the optical medium.

10. The method of claim 9 wherein reading the plural writes to select a write strategy having a desired readability further comprises comparing error rates of the plural writes to select the write strategy having the best readability.

11. The method of claim 10 wherein comparing error rates further comprises comparing C1 and C2 error rates derived from optical drive error detection and correction processes.

12. The method of claim 9 further comprising:
storing the selected write strategy on the optical drive indexed to the optical medium identification;
detecting subsequent insertion of an optical medium into the optical drive, the optical medium having the optical medium identification; and
writing information to the optical medium with the selected write strategy.

13. The method of claim 9 wherein performing plural writes of test information to the optical medium with plural write strategies further comprises:
generating a test information pattern to write to the optical medium;
generating plural write strategies, each write strategy having incremental adjustments to one or more write parameters; and
writing a test information pattern to the optical medium with each write strategy.

14. The method of claim 13 wherein writing the test information pattern to the optical medium with each write strategy further comprises performing the write of the test patterns with a single write operation.

15. The method of claim 13 wherein writing the test information pattern to the optical medium with each write strategy further comprises:
performing one or more incremental reads between the writes; and
adjusting the write strategy of subsequent writes in response to the readability of the incremental reads.

16. An optical drive for writing information to an optical medium having an optical medium identification, the optical drive comprising:
a laser aligned to write information on the optical medium according to a selected one of plural write strategies;
a write strategy table storing plural write strategies by associating each of the plural write strategies with an optical medium identification;
an error detection and correction module operable to detect and correct errors in a write of information;
a write module interfaced with the laser and the error detection and correction module, the write module operable to read the optical medium identification from the optical medium and to set the laser to write the information to the optical medium with a write strategy from the write strategy table that is associated with the optical medium identification, the write module further operable to write the information to the optical medium with a generic write strategy if a write strategy associated with the optical medium identification is not found in the write strategy table; and
a write strategy development module interfaced with the write module and operable to create one or more test patterns and plural test write strategies, the write strategy development module further operable to communicate the test patterns and test write strategies to the write module for writing to the optical medium to select a test write strategy for the optical medium that writes a test pattern with the best readability.

17. The optical drive of claim 16 wherein the write strategy development module is further operable to store the selected test write strategy in the write strategy table, the selected test write strategy associated with the optical medium identification.

18. The optical drive of claim 16 wherein the best readability comprises the test write strategy that writes a test pattern to the optical medium with the lowest C1 and C2 error rates.

19. The optical drive of claim 16 wherein the optical medium comprises a writable DVD disk.

20. The optical drive of claim 16 wherein the optical medium comprises a writable CD disk.

21. The optical drive of claim 16 wherein the best readability comprises the test write strategy that writes a test pattern to the optical medium with the lowest jitter rate.
